(19) United States
(12) Patent Application Publication
(10) Pub. No.: US 2023/0073452 A1
(43) Pub. Date: Mar. 9, 2023

(54) ON-DEMAND MEDICAL AND PROTECTIVE MASK MAKING SYSTEM

(71) Applicant: Synkron Biosciences Corporation, Sarasota, FL (US)

(72) Inventors: Joseph A. Bobier, Berea, WV (US); Phillip Jackson, Sarasota, FL (US)

(21) Appl. No.: 17/902,041

(22) Filed: Sep. 2, 2022

Related U.S. Application Data
(60) Provisional application No. 63/240,403, filed on Sep. 3, 2021.

(51) Int. Cl. G07F 17/00; B65B 55/12; B65B 5/04; B65B 61/02; A41H 43/02; A41D 13/11; G06Q 10/08

(52) U.S. Cl. CPC G07F 17/0014; B65B 55/12; B65B 5/045; B65B 61/025; A41H 43/02; A41D 13/11; G06Q 10/087

(57) ABSTRACT

A self-contained medical and protective mask manufacturing system, which can be located anywhere there is floor space for a device the approximate size of a soft drink vending system, and where masks are produced on-demand, in any quantity up to the limit of the raw materials contained within the system or the capacity of the dispensing chute, is disclosed.

### CROSS-REFERENCE TO RELATED APPLICATION

The present application claims the benefit of previously filed co-pending Provisional Patent Application, Ser. No. 63/240,403 filed on Sep. 3, 2021.

### FIELD OF THE INVENTION

The device of this disclosure is a self-contained medical and protective masks manufacturing system, which can be operated by a single operator. More specifically, the system could be located at a hospital, hospital ward, government building or any facility that uses or requires use of medical face masks. By placing the system at the point of use, the user is assured of quality, sterility, point of origin and continuous supply, eliminating the logistics of stockpiling masks and uncertainty of mask quality from unknown sources.

### BACKGROUND OF THE INVENTION

The current state of the art in the field of manufacturing medical and protective masks is a large centralized factory, generally using very large and expensive mechanical apparatus to weld mask fabrics together using ultrasonic presses and rotary presses to cut mask outlines from multiple layers of fabric. From this facility, masks are bundled, boxed and shipped to distributors or customers. During manufacture, the masks and raw materials may be touched by several workers. During shipping, the cartons are exposed to any number of environments and handlers.

The on-demand medical and protective mask making system as shown in this disclosure ensures the user is assured of quality, sterility, point of origin and continuous supply, eliminating the logistics of stockpiling masks and uncertainty of mask quality from unknown sources.

### BRIEF SUMMARY OF THE INVENTION

The invention can produce medical and protective face masks on demand using raw materials located inside or adjacent to the system. The system can be located at the point of use, eliminating ordering and inventorying of finished masks.

### BRIEF DESCRIPTION OF THE DRAWINGS

For a fuller understanding of the nature and objects of the invention, reference should be made to the following detailed description, taken in connection with the accompanying drawings, in which:

FIG. 1 shows a diagram of a preferred embodiment of the invention.

### DESCRIPTION OF THE PREFERRED EMBODIMENT

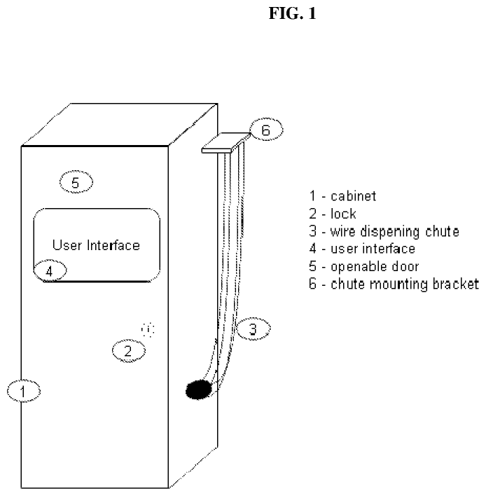

The preferred embodiment of this disclosure as shown in FIG. 1 is a self-contained medical and protective mask manufacturing system, which can be located anywhere there is floor space for a device the approximate size of a soft drink vending system and where masks are produced on-demand, in any quantity up to the limit of the raw materials contained within the system, or the capacity of the dispensing chute. The system can produce medical and protective face masks on demand using raw materials located inside or adjacent to the system to produce, sterilize, bag and dispense the masks. The system can be located at the point of use, eliminating ordering and inventorying of finished masks.

Other embodiments are obvious to the inventors which could customize the invention to meet the needs of smaller or larger institutions and the production of fewer or more quantities of masks dispensing them singly or in volume. However, the invention is not simply a vending system which dispenses finished goods. The present invention manufactures the masks upon demand.

In FIG. 1, element 1 depicts the external cabinet (1) of the system, comprised of a cabinet (1) with one or more openable doors (5). Element 2 depicts a key lock (2) on each openable door. Element 3 depicts a vertical chute (3), comprised of formed wire rods, a mounting bracket/cap which retains chute (3) form and attaches the chute (3) to the cabinet (1). Element 4 depicts a user interface (4), typically comprised of an LCD touch screen (4). Element 5 depicts the front openable door (5). Doors (5) on other sides could be included for convenience. And finally, element 6 depicts the chute (3) top cap and mounting bracket (6). The top cap and mounting bracket (6) hold the formed rods in place and secures them to the cabinet (1).

Medical and protective masks are generally defined by the N-95 design and standards but could be produced to meet any design and/or standards. Masks are generally composed of multiple layers of non-woven fabric, one or two elastic head or ear bands, and an embedded wire nose bridge which can be bent and formed by the user to fit the face.

The system can be configured to produce masks which conform to any accepted standard using any of these raw materials or other materials that are used in disposable face masks. Raw materials for the manufacture of the face mask are supplied to the system through insertable cartridges (not shown), which can be replaced on-site by an authorized user. For high-capacity applications, fabric can be input through other methods known to those skilled in the art. Cartridges can be returnable to the vendor for sterilization and refilling, or disposable. The cartridge has an intrinsic seal which is punctured or opened upon insertion into the system, thus raw materials are never exposed to human contact.

A user interface (4) placed on the cabinet (1), generally to be embodied by an LCD touch screen (4), allows the operator to choose the number of masks to be manufactured and dispensed. Other user interface (4) designs, such as those using buttons, voice control, switches, and knobs, are obvious, anticipated, and known to the inventor. In various embodiments, the user interface (4) can also provide current status, such as amount of raw material remaining, technical access for testing and calibration, an optional user defined unlock code to restrict operation to authorized users, user initiated raw material reordering, and to enable auto-reordering as well as other system functions as required. All user interface (4) activities can be accessed by remote digital interface.

The cabinet (1) which contains the system is lockable using a key lock (2) on the door (5) and accessible by key or other security measure, as are internal lockable bays to prevent human contact with the materials, for safety, authorized maintenance access and to prevent tampering.

In one embodiment of the invention, the system takes the general size and shape of a vending system, which upon demand can manufacture, sterilize, bag, and dispense medical or protective masks in any quantity required by the user, up to the limit of raw materials contained within the system or the chute (3) capacity. Finished masks are ejected from the system into a vertical chute (3) and are available to the user by pulling through the formed rods which comprise the chute (3).

In a 2^{nd} embodiment, the masks can be custom printed at the time of manufacture with any identifying text or marks the user may wish.

In a 3^{rd} embodiment, the system can display internal mask making inventory levels on the user interface.

In a 4^{th} embodiment, the system can be configured to automatically re-order raw materials.

In a 5^{th} embodiment, the high-capacity vertical chute (3) and top cap and mounting bracket (6) can be replaced with a small dispensing tray (not shown) to hold individual masks which are produced one at a time for individual users.

Since certain changes may be made in the above-described system of a self-contained medical and protective mask manufacturing system without departing from the scope of the invention herein involved, it is intended that all matter contained in the description thereof shall be interpreted as illustrative and not in a limiting sense.

What is claimed is:

1. A self-contained medical and protective masks manufacturing system comprising:
a cabinet;
said cabinet having one or more openable doors for placing raw materials within said manufacturing system;
a key lock on each of said one or more openable doors;
a vertical chute comprised of formed wire rods;
a chute top cap and mounting bracket which retains said chute's shape and attaches said chute to said cabinet;
said cabinet having a user interface; and,
wherein upon user demand on said user interface said manufacturing system can manufacture, sterilize, bag, and dispense medical or protective masks in any quantity required by a user, up to the limit of raw materials that have been placed within said manufacturing system or up to the limit of said vertical chute capacity.

2. The self-contained medical and protective masks manufacturing system of claim 1 wherein the masks can be custom printed at the time of manufacture with any identifying text or marks selected by the user.

3. The self-contained medical and protective masks manufacturing system of claim 1 wherein said user interface can display internal mask making inventory.

4. The self-contained medical and protective masks manufacturing system of claim 1 wherein said manufacturing system can be configured to automatically re-order raw materials.

5. The self-contained medical and protective masks manufacturing system of claim 1 wherein said vertical chute and said chute top cap and mounting bracket can be replaced with a small dispensing tray to hold individual masks which are produced one at a time for individual users.
